(19) United States
(12) Patent Application Publication
(10) Pub. No.: US 2023/0202315 A1
(43) Pub. Date: Jun. 29, 2023

(54) HYDROGEN-BASED POWER STORAGE UNIT

(71) Applicant: Newton Howard, Potomac, MD (US)

(72) Inventor: Newton Howard, Potomac, MD (US)

(21) Appl. No.: 18/062,286

(22) Filed: Dec. 6, 2022

Related U.S. Application Data
(60) Provisional application No. 63/294,062, filed on Dec. 27, 2021.
(60) Provisional application No. 63/409,998, filed on Sep. 26, 2022.

(51) Int. Cl. B60L 50/75; B60L 53/54; B60L 53/51; B60L 53/52; H01M 16/00; H01M 8/0656; H01M 8/04082; H01M 10/46; H02J 15/00

(52) U.S. Cl. CPC B60L 50/75; B60L 53/54; B60L 53/51; B60L 53/52; H01M 16/006; H01M 8/0656; H01M 8/04201; H01M 10/46; H02J 15/008; H01M 2220/20; H01M 2250/20

(57) ABSTRACT

Embodiments may include a hydrogen-based power storage unit device that provides power for electric vehicles, and other uses, without requiring hydrogen refueling infrastructure. For example, in an embodiment, an apparatus may comprise a power source, a water supply, an electrolyzer connected to the power source adapted to separate water from the water supply into hydrogen and oxygen, a fuel cell adapted to generate electrical power using the separated hydrogen and oxygen, and a power conditioning unit adapted to output a configured electrical power output.

### CROSS-REFERENCE TO RELATED APPLICATIONS

This application claims the benefit of U.S. Provisional Application No. 63/294,062, filed Dec. 27, 2021, and U.S. Provisional Application No. 63/409,998, filed Sep. 26, 2022, the contents of which are incorporated herein in their entirety.

### BACKGROUND

The present invention relates to a hydrogen-based power storage unit device that provides power for electric vehicles, and other uses, without requiring hydrogen refueling infrastructure.

Driven by the desire to contribute to the environment, more and more famous vehicle brands are producing vehicles that don't bring polluting emissions. The technology of “green” vehicles has taken two main approaches: electrical vehicles and hydrogen vehicles. Both technologies are ultimately driven by electric motors. However, the major difference is that electrical vehicles take energy from an electrical grid and store it in a sequence of lithium-ion batteries while hydrogen vehicles use the principle of reverse electrolysis via tanks filled with hydrogen. The difference in power delivery architecture brings various advantages and disadvantages between these technologies.

Despite having an advantage in speed of refilling tanks and traveling distance capacity, the hydrogen vehicles have an ultimate challenge—quality/to cost ratio. Starting from the hydrogen station—an undeveloped infrastructure that needs huge investments to be distributed across the globe- and finishing with technology inefficiency in comparison to electric vehicles. For example, many manufacturers are shifting away from FCEV technology.

But while the hopes for fuel cells for passenger cars are fading, they are becoming a reality for commercial vehicles, especially trucks. A number of manufacturers have introduced or plan to introduce vehicles such as vans, trucks, and buses that use hydrogen fuel cells.

The idea now is to create a “hydrogen society” where one day, as proponents hope, people be able to drive fuel cell cars with much less hassle than today. However, the question of whether FCEVs can ever regain the momentum they lost to BEVs is key.

Accordingly, a need arises for techniques hydrogen fuel cell vehicles that do not require a widespread hydrogen refueling infrastructure.

### SUMMARY

Embodiments may include a hydrogen-based power storage unit device that provides power for electric vehicles, and other uses, without requiring hydrogen refueling infrastructure.

For example, in an embodiment, an apparatus may comprise a power source, a water supply, an electrolyzer connected to the power source adapted to separate water from the water supply into hydrogen and oxygen, a fuel cell adapted to generate electrical power using the separated hydrogen and oxygen, and a power conditioning unit adapted to output a configured electrical power output.

In embodiments, the power source may comprise a battery. The power source may comprise a renewable power source, including at least one of solar cells, wind generator, or other renewable power source. The apparatus may be connected to a battery of an electric vehicle and the power conditioning unit may be configured to output electrical power so as to charge the battery of the electric vehicle. The apparatus further may comprise storage for the water supply. The water supply may be refillable. The apparatus further may comprise storage for the separated hydrogen and oxygen. The stored hydrogen and oxygen may be compressed.

In an embodiment, vehicle may comprise a battery configured to supply electrical power to a drive motor of the vehicle; a power source; a water supply; an electrolyzer connected to the power source adapted to separate water from the water supply into hydrogen and oxygen; a fuel cell adapted to generate electrical power using the separated hydrogen and oxygen; and a power conditioning unit adapted to output a configured electrical power output so as to charge the battery of the vehicle.

In embodiments, the power source may comprise a battery. The power source may comprise a renewable power source, including at least one of solar cells, wind generator, or other renewable power source. The vehicle further may comprise storage for the water supply. The water supply may be refillable. The apparatus further may comprise storage for the separated hydrogen and oxygen. The stored hydrogen and oxygen may be compressed.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary schematic representation of viral detection. according to embodiments of the present techniques.

FIG. 2 are exemplary schematic representations of target antibody immobilization on a surface according to embodiments of the present techniques.

FIG. 3 is an exemplary block diagram of Microscale Affinity Chromatography (MAC) according to embodiments of the present techniques.

### DETAILED DESCRIPTION

Embodiments may include a hydrogen-based power storage unit device that provides power for electric vehicles, and other uses, without requiring hydrogen refueling infrastructure.

Hydrogen fuel cells produce electricity by a chemical reaction between hydrogen and oxygen, the only byproduct of which is water. However, to produce hydrogen without using fossil fuels, the reaction needs to be reversed, and this requires a lot of electricity. Ideally, this electricity comes from renewable sources such as wind, otherwise, the point of FCEV is lost. The BEV argument is. that putting that clean electricity right into the battery saves a lot of power. The FCEV counterargument is that there may not be enough batteries to store the renewable energy when it is generated; like on a windy night. Hydrogen can convert excess electricity from wind or solar into hydrogen that can be stored in huge quantities.

Fuel cell technology despite all of its promising benefits is less than half as efficient as an electric vehicle if an entire energy chain to power up a vehicle is considered. Electrolysis, which is an inherently inefficient process, is needed to separate the hydrogen, after which it is compressed, transported, stored under the maintained pressure, and converted back into electricity. The power conversion problem, as well as the high costs of hydrogen fuel cell technology, makes it clear that the application to electric vehicles is a better solution. The main issue with electric cars is underdeveloped infrastructure. The number of electric stations can strongly vary on a city-to-city scale. Ultimately, this has become one of the main concerns of owners of electric cars.

In embodiments, the hydrogen fuel cell may be utilized as a portable power station. Embodiments may be used as a supplementary technology for electric vehicles to complete the technology, eliminate the discomfort of owners of electric vehicles, and introduce a completely new approach to recharging an electric car. Embodiments may be used charge an electric car anytime and anywhere with just distilled water.

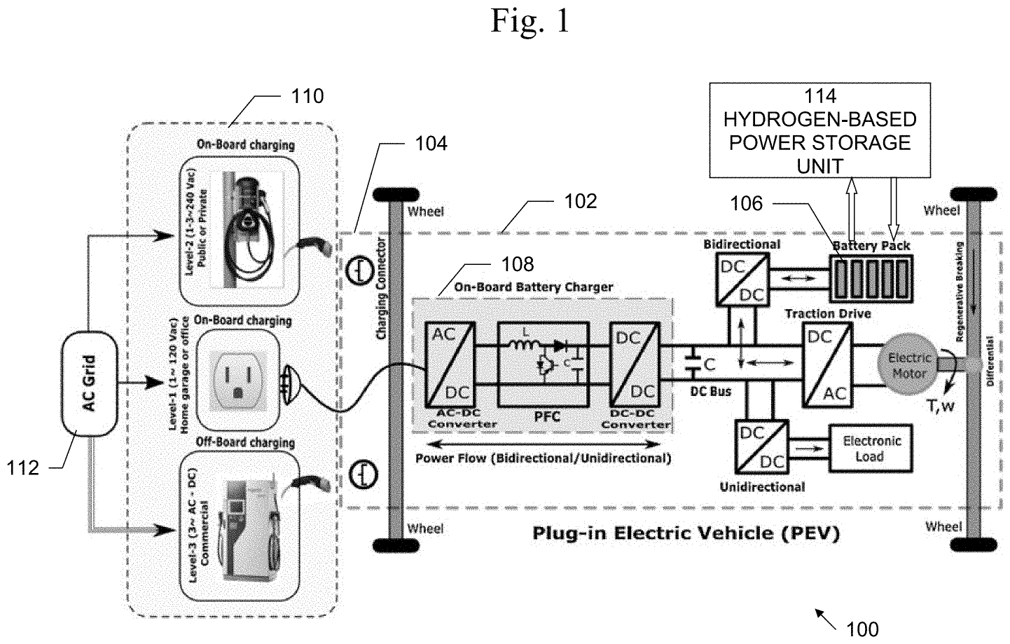

An exemplary system 100 in which embodiments may be used is shown in FIG. 1. System 100 may include a Plug-in Electric Vehicle (PEV) 102, such as a Battery Electric Vehicle (BEV), which may include charging connections 104, Battery Pack 106, On-Board Battery Charger 108, etc., charging devices 110, which may be connected to AC Grid 112, and Hydrogen-Based Power Storage Unit 114. Conventionally, Battery Pack 106 may be charged using On-Board Battery Charger 108 as powered by AC Grid 112 using charging devices 110 and connected using charging connections 104. In embodiments, Battery Pack 106 may be charged using Hydrogen-Based Power Storage Unit 114. In embodiments, Hydrogen-Based Power Storage Unit 114 may be disposed internally in vehicle 102, or may be external to vehicle 102 and may be portable or transportable.

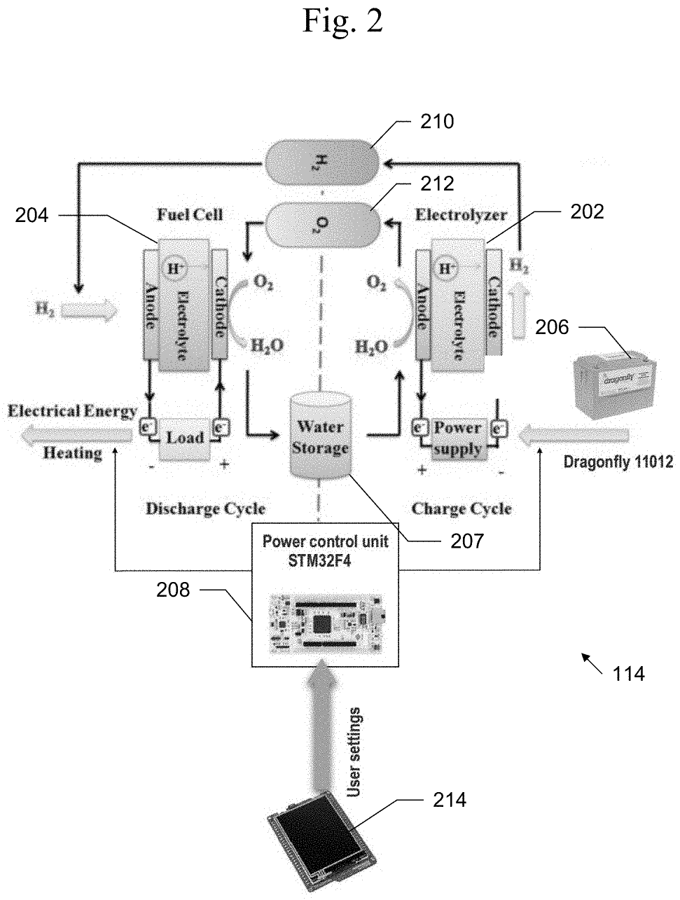

An exemplary embodiment of a Hydrogen-Based Power Storage Unit 114 is shown in FIG. 2. In this example, Hydrogen-Based Power Storage Unit 114 may include a combination of electrolyzer 202, fuel cell (reverse electrolyzer) 204, power source 206, such as a battery, renewable power source, such as solar cells, wind generator or other renewable power source, or other power source, refillable water storage 207, electronic components such as power control/voltage converters/stabilizers 208, and hydrogen storage 210 and oxygen storage 212. In operation, power source 206, such as a Dragonfly 11012 battery, or other power source, may develop a potential difference, such as 12 volts, between the cathode and anode of the electrolyzer, which may be placed inside, for example, a 30 cm×10 cm×10 cm water tank. Water, exposed to the voltage difference, may be disintegrated into oxygen and hydrogen. The two gases may be stored 210, 212 and/or supplied through separate tubes to fuel cell 204 with its anode and cathode, developing a potential difference and, hence, a current due to the operation of the polymer exchange membrane. The anodes and cathodes of fuel cell 204 may be electrically connected to an electric vehicle's internal battery via electrical DC/DC converters and voltage stabilizers 208. The approach of retrieving hydrogen from water and then converting it into electrical energy can seem overcomplicated. However, this approach allows an owner of an electric vehicle to install a small portable system, that allows charging a vehicle at any time just by pouring a bottle of water into a tank. Embodiments may serve as a compact, portable, and extremely easy-to-use power bank for an electric vehicle. As a power bank, embodiments may also be charged at a power station or local socket, but can be transported, used at any random intervals, and utilized by using a bottle of water in a nearby store. Hydrogen storage 210 and oxygen storage 212 may store the gases at ambient pressure, or may further include compressors to compress the gases for more efficient storage.

The electrolyzer 202 may disintegrate water from tank 207 into hydrogen and oxygen in the presence of the applied voltage. Both gases are needed to generate electricity and ultimately charge an electric vehicle's internal battery. The quantities of emitted gas are controlled by the voltage applied to the anode and cathode of electrolyzer 202. The fuel cell's 204 purpose is to generate electricity across an electric vehicle's native battery terminals. This is achieved due to the polymer exchange membrane. A power source 206, such as renewable power source, such as solar cells, wind generator or other renewable power source, or other power source may directly power electrolyzer 202 or may charge a battery 206 as the power source 206 of Hydrogen-Based Power Storage Unit 114. For example, a lithium cobalt-oxide battery may be used as this has high energy density.

A refillable water tank 207 may serve as a reusable source of energy catalyst. Owners of cars would be able to use distilled water from a shop to fill up the water tank for the electrolysis and reverse electrolysis procedures. A microcontroller, which may be included in Power control 208, may control the Hydrogen-Based Power Storage Unit 114 and enable a user to determine his/her inputs to the system, such as available time for charging vehicles as well as maximum and minimum time required. A touchscreen display 214 may provide the capability for a user to interface with the microcontroller, and enter or correct desired data such as time of charge or desired percentage of charge.

The microcontroller may increase or decrease the amount of power in the system by increasing or decreasing the voltage applied to the anodes and cathodes of an electric car's native battery. Additionally, the microcontroller may store and analyze the data of Hydrogen-Based Power Storage Unit exploitation as well as geolocation, maps, and car routes to derive the best strategy for a driver. Power control 208 may include high-power stabilizers to reduce and minimize the impact of sudden current demands and surges.

The material of anode and cathode of electrolyzer 202 plays a key role on the rate of charge transfer and, hence, on the full capacity of electrolysis. Additionally, the exploitation of conventional electrodes should be avoided for long-term solutions. The material of anode and cathode of fuel cell 204 plays a key role on the rate of charge transfer and, hence, on the full capacity of electrolysis. Additionally, the exploitation of conventional electrodes should be avoided for long-term solutions.

A battery, such as the Dragonfly 10012, may be utilized due to its specifications, including 100 ampere-hours, 3000-5000 cycles at 100% capacity, and protection against sudden current surges. Water tank 207 may be designed to ensure no mechanical mismatch between systems. Power control 208 may include a microcontroller, such as the STM32F4, with specifications such as 80 MHz CPU/225 DMIPS, up to 2 Mbytes of dual-bank Flash memory with SDRAM and Chrom-ART Accelerator, may be used. Touch screen 214 may be a smart programmable touch screen with features such as a full-colored resistive touch screen, WiFi module, programmer debugger, 8 Mbit of Serial Flash, microSD card slot, VS1053 MPEG audio decoder, Piezo Buzzer, USB OTG connector, Temp. sensor, RTC battery, PIN photosensor, Accelerometer, Battery Charger, and headers for additional connection. Power control 208 may include a DC-DC Adjustable voltage converter, for example, 1800W 40A. The control of high currents through this converter will be executed via implementing Darlington transistors of sufficient current rating.

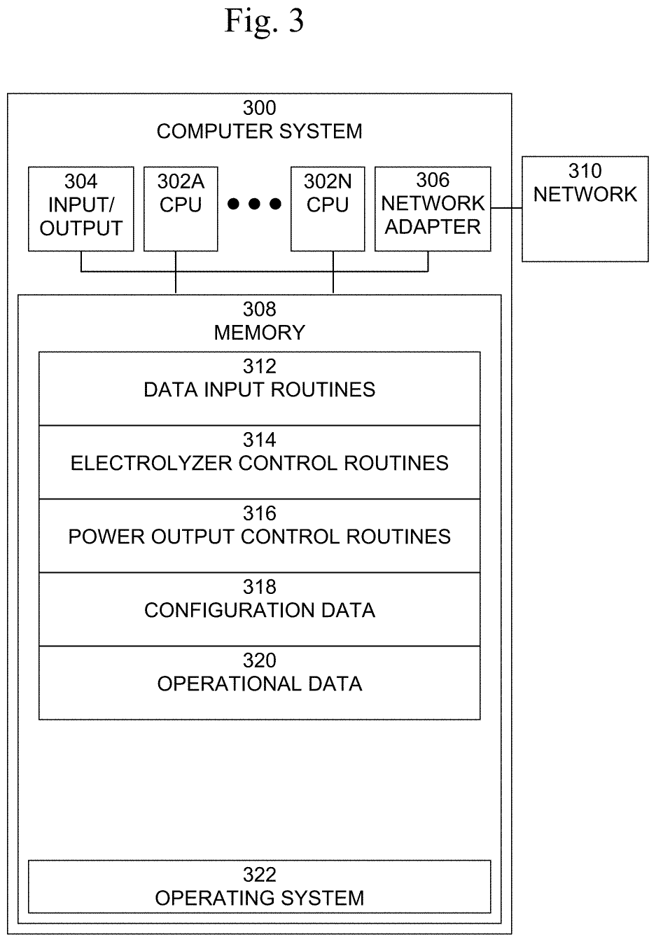

An exemplary block diagram of a computing device 300, which may be included in Power control circuitry 208, shown in FIG. 2, in which processes involved in the embodiments described herein may be implemented, is shown in FIG. 3. Computing device 300 may be a programmed general-purpose computer system, such as an embedded processor, microcontroller, system on a chip, microprocessor, smartphone, tablet, or other mobile computing device, personal computer, workstation, server system, and minicomputer or mainframe computer. Computing device 300 may include one or more processors (CPUs) 302A-302N, input/output circuitry 304, network adapter 306, and memory 308. CPUs 302A-302N execute program instructions in order to carry out the functions of the present invention. Typically, CPUs 302A-302N are one or more microprocessors, such as an INTEL PENTIUM® processor. FIG. 3 illustrates an embodiment in which computing device 300 is implemented as a single multi-processor computer system, in which multiple processors 302A-302N share system resources, such as memory 308, input/output circuitry 304, and network adapter 306. However, the present invention also contemplates embodiments in which computing device 300 is implemented as a plurality of networked computer systems, which may be single-processor computer systems, multi-processor computer systems, or a mix thereof.

Input/output circuitry 304 provides the capability to input data to, or output data from, computing device 300. For example, input/output circuitry may include input devices, such as keyboards, mice, touchpads, trackballs, scanners, etc., output devices, such as video adapters, monitors, printers, etc., and input/output devices, such as, modems, etc. Network adapter 306 interfaces device 300 with a network 310. Network 310 may be any public or proprietary LAN or WAN, including, but not limited to the Internet.

Memory 308 stores program instructions that are executed by, and data that are used and processed by, CPU 302 to perform the functions of computing device 300. Memory 308 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

In the example shown in FIG. 3, memory 308 may include data input routines 312, electrolyzer control routines 314, power output control routines 316, configuration data 318, operational data 320, and operating system 322. For example, data input routines 312 may include routines that interact with a user and may provide the capability for a user to interface with the microcontroller, and enter or correct desired data such as time of charge or desired percentage of charge. Electrolyzer control routines 314 may include routines to control operation of the electrolyzer, such as by increasing or decreasing the voltage applied to the anodes and cathodes of an electric car's native battery. Power output control routines 316 may include routines to control operation of the fuel cell and of the power converter and control circuitry. Configuration data 318 may include data entered by the user to configure the device, as well as manufacturer or other configuration data. Operational data 320 may include data collected during operation of the device. Operating system 322 provides overall system functionality.

As shown in FIG. 3, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry (such as that shown at 208 of FIG. 2) may include, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. An apparatus comprising:
a power source;
a water supply;
an electrolyzer connected to the power source adapted to separate water from the water supply into hydrogen and oxygen;
a fuel cell adapted to generate electrical power using the separated hydrogen and oxygen; and
a power conditioning unit adapted to output a configured electrical power output.

2. The apparatus of claim 1, wherein the power source comprises a battery.

3. The apparatus of claim 1, wherein the power source comprises a renewable power source, including at least one of solar cells, wind generator, or other renewable power source.

4. The apparatus of claim 1, wherein the apparatus is connected to a battery of an electric vehicle and the power conditioning unit is configured to output electrical power so as to charge the battery of the electric vehicle.

5. The apparatus of claim 1, further comprising storage for the water supply.

6. The apparatus of claim 5, wherein the water supply is refillable.

7. The apparatus of claim 1, further comprising storage for the separated hydrogen and oxygen.

8. The apparatus of claim 7, wherein the stored hydrogen and oxygen are compressed.

9. A vehicle comprising:
a battery configured to supply electrical power to a drive motor of the vehicle;
a power source;
a water supply;
an electrolyzer connected to the power source adapted to separate water from the water supply into hydrogen and oxygen;
a fuel cell adapted to generate electrical power using the separated hydrogen and oxygen; and
a power conditioning unit adapted to output a configured electrical power output so as to charge the battery of the vehicle.

10. The vehicle of claim 9, wherein the power source comprises a battery.

11. The vehicle of claim 9, wherein the power source comprises a renewable power source, including at least one of solar cells, wind generator, or other renewable power source.

12. The vehicle of claim 9, further comprising storage for the water supply.

13. The vehicle of claim 12, wherein the water supply is refillable.

14. The vehicle of claim 9, further comprising storage for the separated hydrogen and oxygen.

15. The vehicle of claim 14, wherein the stored hydrogen and oxygen are compressed.
